(19) United States
(12) Patent Application Publication
(10) Pub. No.: US 2011/0264613 A1
(43) Pub. Date: Oct. 27, 2011

(54) METHODS, APPARATUS AND SYSTEMS USING PROBABILISTIC TECHNIQUES IN TRENDING AND PROFILING

(76) Inventors: Mark D. Yarvis, Portland, OR (US); Rita H. Wouhaybi, Portland, OR (US); Philip Muse, Folsom, CA (US); Lenitra M. Durham, Beaverton, OR (US); Sai P. Balasundaram, Beaverton, OR (US); Sangita Sharma, Portland, OR (US); Chieh-Yih Wan, Beaverton, OR (US); Giuseppe Raffa, Portland, OR (US)

(21) Appl. No.: 13/163,949

(22) Filed: Jun. 20, 2011

Related U.S. Application Data
(62) Division of application No. 13/130,734.

(51) Int. Cl. G06F 15/18; G06N 5/02

(52) U.S. Cl. 706/12; 706/52

(57) ABSTRACT

An embodiment of the present invention provides a mobile device, comprising a processor adapted to use probabilistic techniques in trending and profiling of a user of the mobile device's behavior in order to offer recommendations by detecting patterns in the user behavior over time and thereby enabling said mobile device to predict what the user is likely to do on a given day or what the user intends to accomplish in an action that has begun.

### CROSS REFERENCE TO RELATED APPLICATIONS

The present application is a divisional application of U.S. patent application serial number 13/130,734, filed 23 May 2011, entitled, “SYSTEMS, APPARATUS AND METHODS USING PROBABILISTIC TECHNIQUES IN TRENDING AND PROFILING AND TEMPLATE-BASED PREDICTIONS OF USER BEHAVIOR IN ORDER TO OFFER RECOMMENDATIONS”, by Yarvis et al; which was a U.S. national stage patent application of PCT patent application serial number PCT/US2009/068129, filed 15 Dec. 2009, entitled, “SYSTEMS, APPARATUS AND METHODS USING PROBABILISTIC TECHNIQUES IN TRENDING AND PROFILING AND TEMPLATE-BASED PREDICTIONS OF USER BEHAVIOR IN ORDER TO OFFER RECOMMENDATIONS”, by Yarvis et al.

### BACKGROUND

The rapid development of wireless devices and their ever-improving capabilities have enabled users to communicate and obtain vast information while being highly mobile. Users of such devices are increasingly able to capture contextual information about their environment, their interactions, and themselves on various platforms. These platforms include, but are not limited to, mobile computing/communication devices (e.g., PDAs, phones, MIDs), fixed and portable computing devices (laptops and desktops), and cloud computing services and platforms. Both raw context and profiles derived from this context have a potentially high value to the user, if the user can properly manage and share this information with service providers. Service providers may use this information to better tailor offers to the user, to better understand their customers, or to repackage and sell (or otherwise monetize).

The user potentially stands to benefit through a better service experience or through a specific incentive. The user's ability to leverage this context is currently limited in the following ways: there is no automated way to share, combine, or integrate context across platforms owned by the same user; there is no automated and/or standardized way for the user to share this context with service providers, with or without compensation; and there is no simple mechanism for controlling access to context.

While shopping online, users typically interact with a web based interface, browsing through product lists and performing searches. Searches can be for a combination of product category, brand name, or specific product identifiers (e.g., model numbers). Both the searches themselves and the pages viewed (both the sites viewed and the contents of the specific pages) provide clues about the user's in-market interests for products.

In considering human behavior, many times users will act in patterns, thereby creating predictable behavior. By detecting these patterns in user behavior over time, a personal device can predict what a user is likely to do on a given day or what a user intends to accomplish in an action that has begun. As a result, a personal device can tailor its interfaces or proactively act on a user's behalf.

Thus, a strong need exists for systems, apparatus and methods using probabilistic techniques in trending and profiling and template-based predictions of user behavior in order to offer recommendations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts building blocks of embodiments of the present invention;

FIG. 2 shows architectures according to embodiments of the present invention;

FIG. 3 illustrates a screen interaction diagram according to embodiments of the present invention

FIGS. 4 and 5 depicts four PDA screen shots with shopping goal details according to embodiments of the present invention;

FIG. 6 shows PDA screens with the ability to scan a UPC code on a PDA according to embodiments of the present invention;

FIG. 7 shows a series of PDA screens in which users can select desired features according to embodiments of the present invention;

FIG. 8 shows recommendation results on a PDA according to embodiments of the present invention; and

FIG. 9 illustrates a PDA completing the function of identification and up-leveling according to embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

As mentioned above, computing platforms are increasingly capable of capturing contextual information about users, including their environment, their interactions, and themselves. These platforms may include, but are not limited to, personal devices such as mobile computing/communication devices (e.g., PDAs, phones, MIDs), fixed and portable computing devices (laptops and desktops), and cloud computing services and platforms. Both raw context and profiles derived from this context have a potentially high value to the user, if the user can properly manage and share this information with service providers. Further, embodiments of systems of the present invention may provide a personal device to be a platform that is an information assimilation and communication platform.

Embodiments of the present invention are capable of detecting patterns in user behavior over time, which may enable a personal device to predict what a user is likely to do on a given day or what a user intends to accomplish in an action that has begun. As a result, a personal device of embodiments of the present invention may tailor its interfaces or proactively act on a user's behalf.

The present invention comprises systems, apparatus and methods that will look at a user of a personal device's actions over time (whether they are places visited, movies watched, items purchased, people meetups, or any combination of those) and create a definition of each of these activities. Features and commonalities among these activities are then extracted. For example, activity 1 might be takeout food from McDonald's on a weekday with daughter, while activity 2 is drive from McDonald's to home. Transitions from one activity to another are then assigned a probability based on the data collected. The probability constitutes a score that can be used to influence recommendations that reflect a prediction of what the user is likely to do next. Example operation of embodiments of the present invention may be exemplified as follows: On Tuesday, the system detects that the user has just picked up her daughter from school. The system predicts that the two will now want to go out to lunch, likely at a local McDonald's, as they often do after school on Tuesday. The system then scans traffic reports, identifies an accident on route to the nearest McDonald's, presents the user with an alternative fast food restaurant that the user might like, and suggests an efficient route to the restaurant and then home. In another case, when the user is out of town, the system would keep in mind the activities enjoyed by the user and how they change according to other accompanying individuals in order to suggest places and events.

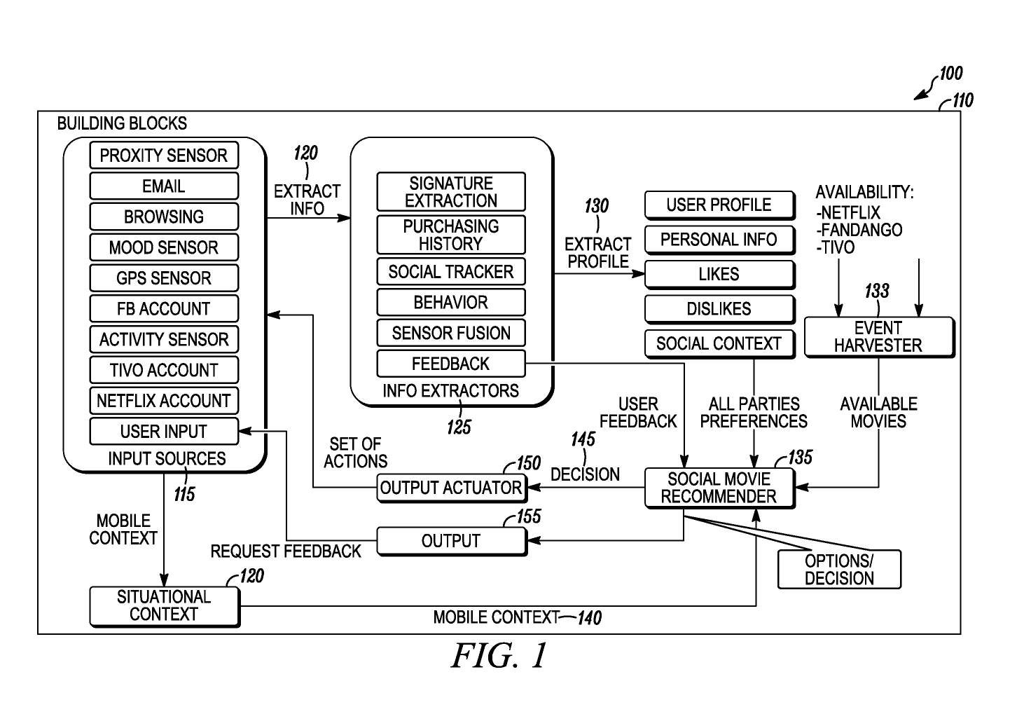

Turning now to the figures, FIG. 1, shown generally as 100, shows exemplary building blocks 110 according to embodiments of the present invention and may start with input sources 115. Input sources may include, for example but not limited to, proximity sensor, email, browsing, mood sensor, GPS sensor, a social networking service account (such as Facebook FB), activity sensor, proximity sensor (detect nearby persons), TiVo account, NetFlix account and user input just to name a few. Info extractors at 125 will not only extract and abstract information coming from one input source, but can also understand and correlate information from more than one sensor in order to understand the behavior and preferences of a user. For example, the Social Tracker will use information coming from a FB account and TiVo account in order to suggest to a user TV shows that people in her social network are watching and enjoying. Info extractors 125 may include, but are not limited to, signature extraction, purchasing history, social tracker, behavior, sensor fusion and feedback. A profile may be extracted at 130, with the profile being exemplified as User Profile, Personal Info, Likes, Dislikes and Social Context. The extracted information can be for one or more users depending on who is going to be part of the decision and recommendation. The profile will also include public information for users but will preserve users' privacy depending on how they share information from their input sources 115. After profile extraction all parties' preferences and user feedback are input to social movie recommender. Event harvester 133, which might determine available movies, restaurants, or other activites, may also be input to social movie recommender in an embodiment of the present invention. Also input to social movie recommender 135 may be mobile context information 140 that was received from situational context 120 that was output from input sources 115. An example of Mobile Context at 140 can be location of users (from GPS sensors and/or user input). The above information is input into the Social Recommender 135, which synthesizes individual preferences and context into group preferences, previous behavior, and context and matches it with available events to deliver a decision 145. The decision 145 can include a list of recommendations ordered by the Social Movie Recommender. The decision 145 proceeds to output actuator 150 for a set of actions provided to the User Input. This mechanism allows the user(s) to provide feedback by requesting additional information about individual recommendations (movies).

Embodiments of the present invention may discover patterns using a goal such as specific things that happen at specific times over and over again and may include: Location, identifying and clustering of these locations; Timing, Duration and Time/date. Patterns may also include people nearby (output from proximity sensor) since this information is part of the context information.

Discovering Patterns may be accomplished by, for example, but not limited to:

User X: Repetitive Routine (work+colleagues during day, home+family member during evening);

8 am-5 pm: GPS=Location 1, Proximity=User Y,

6 pm-7 am: GPS=Location 2, Proximity=User A,

User Y: Repetitive Routine+Cycles (work+colleagues during day, Friday noon+colleagues going out for lunch, home+family member during evening);

Mon-Thu 8 am-5 pm: GPS=Location 1, Proximity=User X,

Fri noon-1 pm: GPS=Location 3, Proximity=User X+User Z,

Mon-Fri 6 pm-7 am: GPS=Location 4, Proximity=User B+User C,

Another example, may include:

User Z: Categories (work during the day, lunch out with one or more colleagues);

8 am-noon and 1 pm-5 pm: GPS=Location 1, Proximity=User X+User Y+User V

Noon-1 pm: GPS=Location[4,5,6,7,8], Proximity=User[X, Y, V]
Output
Show profiles built;
User X is about the same routine -User Y has the routine set in cycles -User Z is about variety with common themes;
User X asks the system for a lunch location with User Y;
System recommends restaurants -System recommends adding User Z;
User Y asks the system for a lunch location on Saturday;
System recommends restaurants that may be children friendly based on User Y, User B, and User C (a child). However, if the system detects the presence of User B (an adult) alone with user Y, then the system would recommend “gourmet” restaurants based on categories of restaurants visited by User Y and User B in the past. In this case, the system does not necessarily see a repetitive pattern for the same restaurant but rather extracts the type of restaurants visited by User Y and User B.

Embodiments of the present invention further provide a teaser application that allows for automatic identification of a user's shopping goals. The teaser application provides a useful service to the user, which is a way to obtain information about products from a mobile device while shopping in a physical store. By interacting with the device, the user can refine their interests and obtain recommendations for alternative products that may better fit their needs. Simultaneously, this system collects information about the user's in-market interests (what they want to buy right now) and overall shopping patterns (where they shop, what kinds of things they typically shop for, how long they browse before they actually buy), allowing opportunities for targeted advertising.

When shopping in a physical store, information about product features, alternative products, and alternative product opportunities, can be hard to come by. A mobile device can be utilized to collect this information and drive recommendations to the user. The user can take a picture of the item of interest, its packaging, or its UPC code, indicating which product is of interest. The device can then list the set of features for this item and allow the user to specify which features are desired, undesirable, or unimportant. This information can be used to drive recommendations for other products of interest. For example, the device may recommend the lowest cost item that contains all required features. Or the device may recommend the best device in its class. As the user reviews these recommended items or scans other items, rating the features of these items as well, the device can build up a profile of the user's in-market interests, desired features, preferred brands, and shopping patterns (frugal, impulsive, etc). The device can track the user's interest, starting with a specific product scanned, broadening to a set of products under consideration, and eventually narrowing back to a specific product that meets the user's needs.

The device can also identify the categories of items this user shops for most often, and also utilize location information to identify favorite stores. Once interest in a particular item has been identified, the device can offer purchasing recommendations based on both local and online shopping opportunities. These recommendations would be based on need (must have this gift today so it can be delivered on time), pricing (including shipping), user impulsiveness, and preferred vendors. Rather than providing a list of all purchasing opportunities, the top opportunities would be presented based on profile information.

If an online transaction is selected, all details (payment, shipping, etc) would be managed by the mobile device. If a physical opportunity is identified, directions and coupons would be offered.

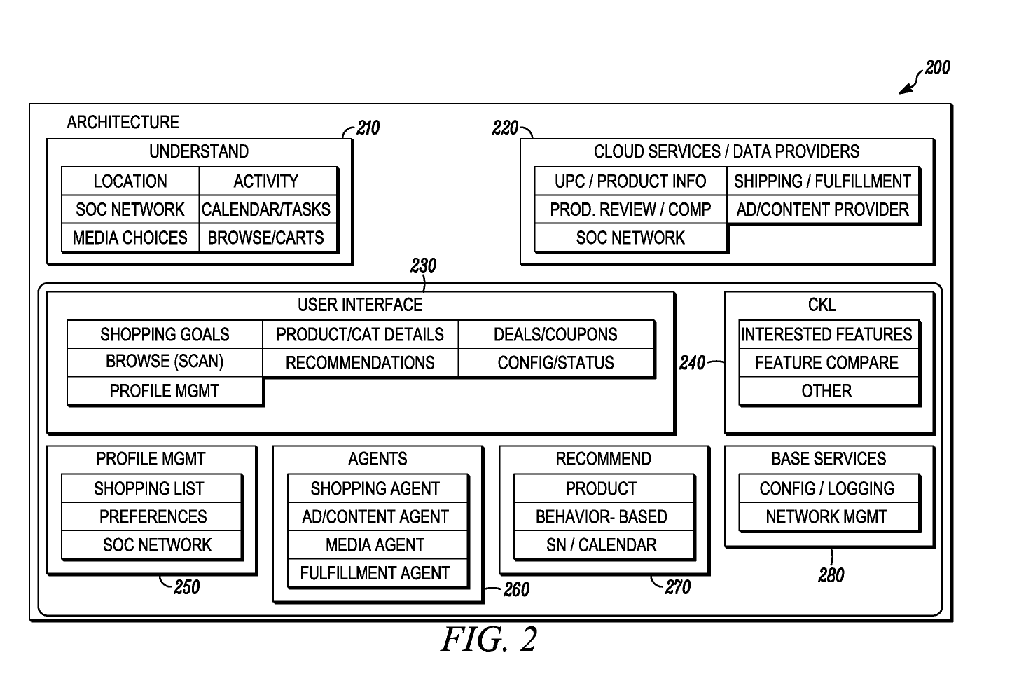

FIG. 2, generally shown as 200, is an example architecture of one embodiment of the present invention. It is understood that is architecture is merely an illustration of many distinct architectures that may be incorporated into the present invention. This architecture may include understand modules 210, cloud services/data providers 220, shopping aid GUI 230, common knowledge layer (CKL) 240, profile management 250, various service agents 260, recommend algorithms 270 and base services 280. Understand modules 210 are code algorithms, hardware and/or other such processing logic whose purpose is to ascertain, sense, calculate and/or derive context about the user, computing device, and/or surrounding environment. These modules may include, but are not limited to: physical location and device orientation; activity; social network data; calendar & task contents; media choices/preferences and internet activity such as: browse/search history and contents of online shopping carts. Cloud services/data providers 220 may include but are not limited to: UPC databases and product information data-sources; shipping & fulfillment services and databases, product review and comparison services and databases; online advertisers/content providers; and social networks.

User Interface 230 elements may include but are not limited to views and interactions with: shopping goals; product/category details; deals/coupons; offer browse; recommendations; configuration/status and profile management. A Common Knowledge Layer (CKL) 240 may include but is not limited to: modules/code/logic that focus recommendations on interested features, culling common redundancies and unimportant features; and feature comparison knowledge that normalizes values across data instances allowing for comparison using standard comparison operators. Profile management 250 is logic used to manage profile data storage and may include but is not limited to: shopping lists; preferences; and social network data. Agents 260 are code modules that provide action, behavior or features in proxy for the user. Agents 260 may include but are not limited to: shopping agents; advertising/content collection agents; media aggregation agents; and fulfillment process agents. Recommend 270 modules may include but is not limited to: product; behavior-based; and serial number/calendar. Base services may include, but is not limited to: configuration management, logging and logging and network connection management.

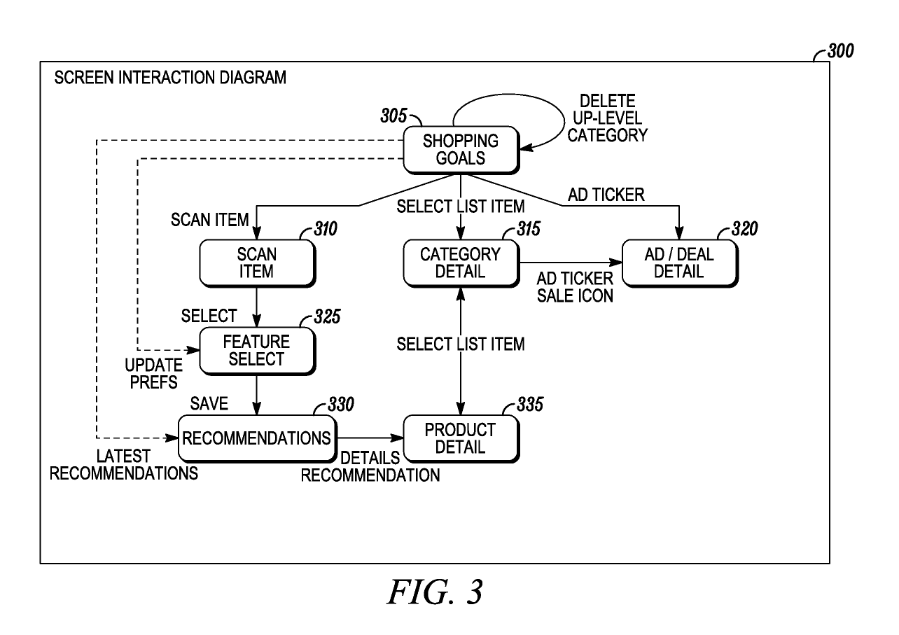

FIG. 3 is a screen interaction diagram 300 of embodiments of the present invention that allows users to utilize a personal device to investigate products and identify shopping goals. Shopping goals shown at 305 is the main entry/exit point to the user interface in this example embodiment. Users can perform operations on their goals manually such as delete a goal, up-level a goal from a specific product to a product category and view category detail 315. From this main view, the user can also navigate to view latest recommendations 330, update their feature preferences 325, view advertisement detail or continue product browsing by scanning another product. Scan item 310 starts a flow of several operations: scan item 310, then feature select 325, then to recommendations 330 and finally product detail 335. Feature select 325 allows the user to interact with product features, specifying and prioritizing their custom preferences for product features. Recommendations 330 shows the various classes of recommendations based on user preferences and past input. Product detail 335 provides a detailed view of features and attributes of a specific product. Selecting a category item in shopping goal 305 starts a flow to category detail 315 where the user can interact with all products he/she has shown interest in within the selected category. From category detail 315, the user can select the ad ticker to view ad/deal detail 320. Selecting ‘delete’ in category detail 315 will delete the category and products of interest within the category. Selecting a list item on category detail view 315 will show product detail 335.

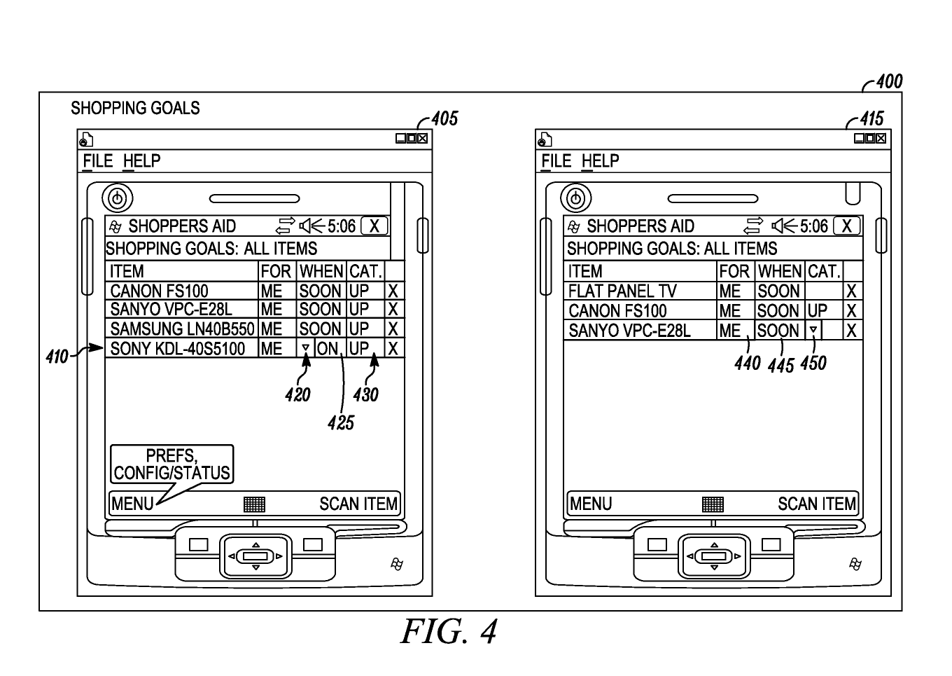

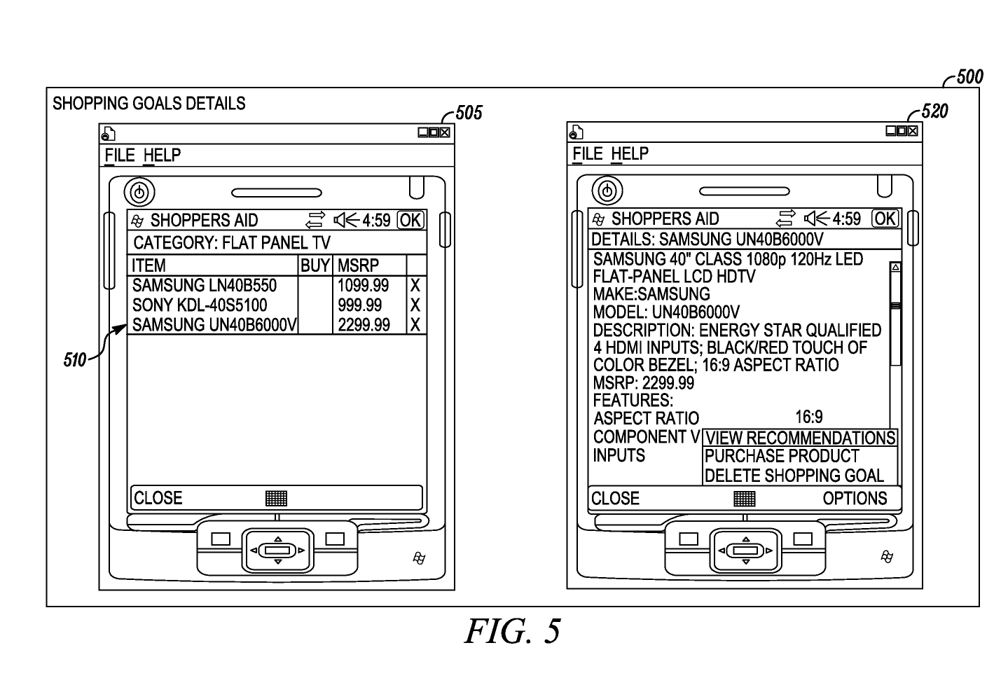

FIG. 4 illustrates generally at 400 shopping goals depicted on a mobile personal device 405 and 415. User at ‘up’ link 430 can up-level their shopping goal, thereby signifying interest in the product category and not necessarily the specific product. Example of up-leveling a flat panel television product at 410 in example view 405 results in example view 415, where the two flat panel TV products are consolidated into an item representing the product category. User at 410 may select one item to get details on that item. Results are shown in FIG. 5 at 505 (if selected item is a category) and at 520 (if selected item is a product). Further, user at 420 and 425 can edit fields from the page shown on personal device 405, with drop downs for the allowed values. The drop down carets to edit fields of device 515 are shown at 540, 545 and 550.

FIG. 5 illustrates generally at 500 an additional personal device with shopping goals depicted on mobile personal devices 505 and 520. 505 depicts a detailed view of products within a category shopping goal. 520 depicts a detailed view of a product selected either from 510 or FIG. 4 at 410.

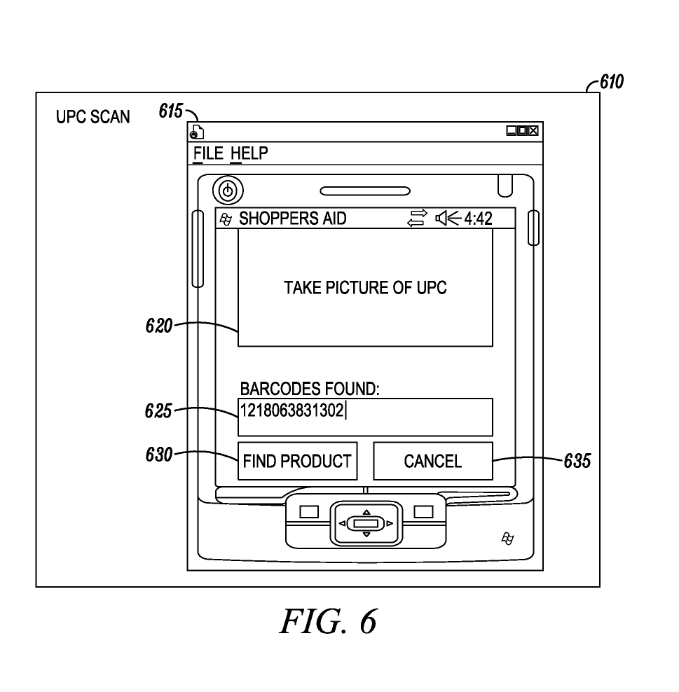

FIG. 6 illustrates UPC scan 610 shown on a personal device 615 according to embodiments of the present invention. On personal device 615 is shown an image button 620 to scan the UPC and window to view captured image. Once image is taken, the embodiment searches the image and displays all discovered barcodes in 625. User can select ‘Find Product’ 630 to initiate a search or cancel the action at 635.

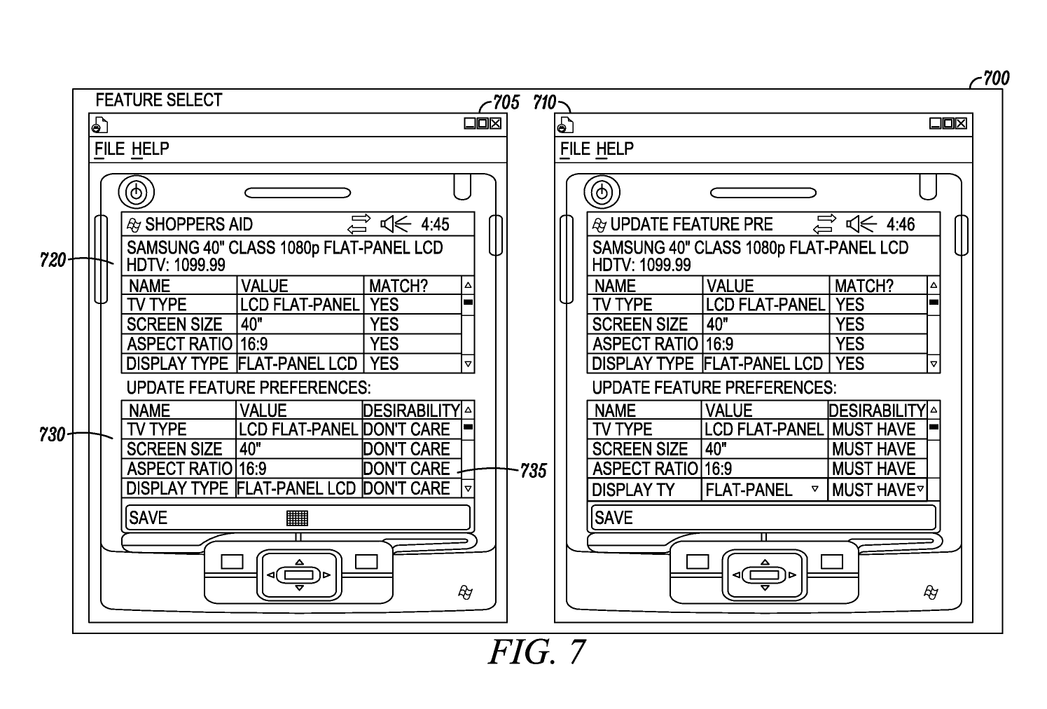

FIG. 7 illustrates generally at 700 a feature select option according to embodiments of the present invention shown on mobile personal devices 705 and 710. Once a product is found from a search initiated at 630, 705 is shown to the user. The product context section 720 shows product information found including all the product features. The feature preference section 730 is populated with features for that product category and the user's desirability preferences saved to this point. The user can change the desirability at 835 and save to continue—Values may include, for example, DON'T CARE, MUST HAVE, MUST NOT HAVE, LIKE TO HAVE. 710 shows example of user changing desirability for four 4 feature preferences to ‘must have’ before continuing.

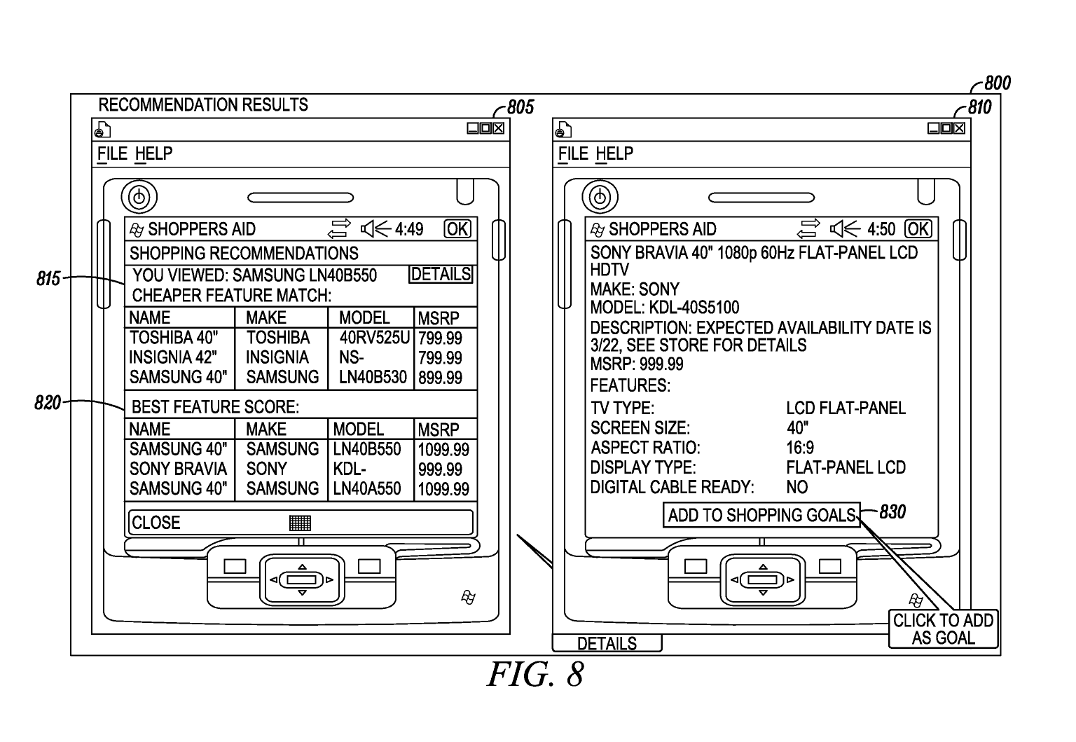

FIG. 8 illustrates generally at 800 recommendation results according to embodiments of the present invention shown on mobile personal devices 805 and 810. The two example algorithms displayed are cheaper feature match 815 and best feature score 820. Cheaper feature match 815 are products less expensive products that meet or beat the product currently scanned using the user's feature preferences as the scorecard. Best feature score 820 uses the feature preferences and scores the best products for the user's preferences. The product detail page at 810 shows the product details for a selected product and allows a user to signify interest in the product using the “add to shopping goals” button at 830.

In one embodiment, a recommendation list, such as those exemplified in 815 and 820, could be generated by combining the user's expressed feature requirements and an additional criteria into a filter and/or score that may be applied to a list of all available products and their corresponding features. Examples of criteria might include lowest cost product that contains all required features, products from a competing manufacturer that contains all required features, best rated product that contains all required features, and closest feature match. To determine if a product meets the required criteria, the list of all available products could be filtered such that no product in the filtered list contains MUST NOT HAVE feature and all products in the filtered list contain the MUST HAVE features. Each product may also then be scored according to a formula specific to the criteria. For example, for lowest cost, the following formula may be applied:

$$Value = {\sum }_{i ∈ features} \{ \begin{matrix}{W}_{i} N , & if i is labeled NICE TO HAVE \\ 0 , & otherwise\end{matrix} - {\sum }_{i ∈ features} {W}_{i} C$$

Where Wᵢ is a weighting for feature I, N is a bonus for NICE TO HAVE features, and C is the cost of the product. In the case of closest feature match, the following formula may be applied:

$$Value = {\sum }_{i ∈ features} \{ \begin{matrix}a , & \begin{matrix}if feature matches and \\ marked MUST HAVE\end{matrix} \\ - b , & \begin{matrix}if feature does not match and \\ marked MUST HAVE\end{matrix} \\ c , & \begin{matrix}if feature matches and \\ marked NICE TO HAVE\end{matrix} \\ d , & \begin{matrix}if feature does not match and \\ marked NICE TO HAVE\end{matrix} \\ - e , & \begin{matrix}if feature matches and \\ marked MUST NOT HAVE\end{matrix} \\ f , & \begin{matrix}if feature does not match and \\ marked MUST NOT HAVE\end{matrix}\end{matrix}$$

Where a is the value of a matching must-have feature, b is the value of an non-matching must-have feature, c is the value of a matching nice-to-have feature, d is the value of a non-matching nice-to-have feature, e is the value of a matching must-not-have feature, and f is the value of a non-matching must-not-have feature. In all of the above examples, products with the highest score could be considered of most interest to the user and thus be displayed.

Embodiments of the present invention provide a system, apparatus and methods for optimizing a route based on goals. On a given day, a user may have a number of things that he needs to purchase or do. Each item could have a priority and a deadline. As he travels from point A to point B (perhaps commuting home at the end of a work day), he has a certain amount of time flexibility that might allow one or more stops. A personal device, such those included above or a mobile information device (MID), which can predict where the user is going and the user's degree of time flexibility, can optimize the route and recommend specific stops along the way. Specific stops may be selected according to the number of goals that can be achieved at a specific stop, with emphasis placed on high priority items or items near their deadline. Specific goals might be related to purchasing. In this case, stops could be optimized according to the total amount of money that will be spent (e.g., if I purchase each item only at the store where it is cheapest, I will save money, but I may have to make many stops). Other goals can also be enabled, e.g., drop off the dry cleaning, deliver an item to a friend, drop off a donation to Good Will, mail a letter.

Embodiments of the present invention may provide an apparatus, system and methods for recommendation-guided one-click set-top purchases. When viewing an advertisement, direct market infomercial, or home shopping show, additional information can be delivered via out-of-band metadata that helps viewers obtain additional information and identify purchasing opportunities. Existing art provides digital video recording users out of band information to allow an extra link to be put on-screen when a commercial is shown. The user can click the link if interested. Embodiments of the present invention enable a user to quickly identify purchasing opportunities that would be directly relevant to them. The user's set-top-box would utilize context received from the user's constellation of devices (for example, but not limited to, home PC, smart phone, MID, etc), develop a profile of the user's purchasing behavior (for example preferred vendors and shipping methods), and automatically offer purchasing opportunities that are most likely to be of interest to the user. When the user selects one of these options, all details of the purchase (payment, shipping, etc) are handled automatically.

Embodiments of the present invention may provide an apparatus, system and methods for template-based prediction and recommendation. Days are often a succession of main events, e.g. Home-Work-Home (basic work day), or Home-Work-Food-Work-Home (work day with lunch out). Embodiments of the present invention may utilize templates that consist of a sequence of activities or locations to characterize a user's day. As the user goes about the day, their personal devices attempt to match pre-existing templates to the user's location and activities, assigning a probability to each template. The matching templates can be used to predict what the user will do next and thus narrow down the set of logical recommendations. For example, if a user will only dine in a upscale restaurant if they had a very easy going day and it is Saturday night, there is no reason to suggest to them an upscale restaurant when they have been hiking all morning. The creation of these templates constitutes another way to define trends. They also serve as a visualization tool where a user can be presented with a calendar colored according to the template of their behavior during that time. For example, Monday through Wed they had very routine days of Home-Work-Home, so they can be colored in dark blue, however they went out to dinner on their way home on Thu and Fri, so the color can be light blue instead. Contextual inputs to these templates are not limited to location. A template might also include inputs such as weather, stock market activity, social interactions, or emotional state.

In an embodiment of the presentation, for example, but not limited in this respect, the following templates were implemented based on GPS data: Regular Work Day=home-work-home; Intense work Day=home-work-home+(more than 9 hours in work, or more than 4 hours of meetings); Fun Work day=home-work-out-work-home or home-work-home-out-home or home-work-home-out-home; Regular weekend day=home; Fun Weekend day=sum all out time is >2 hours.

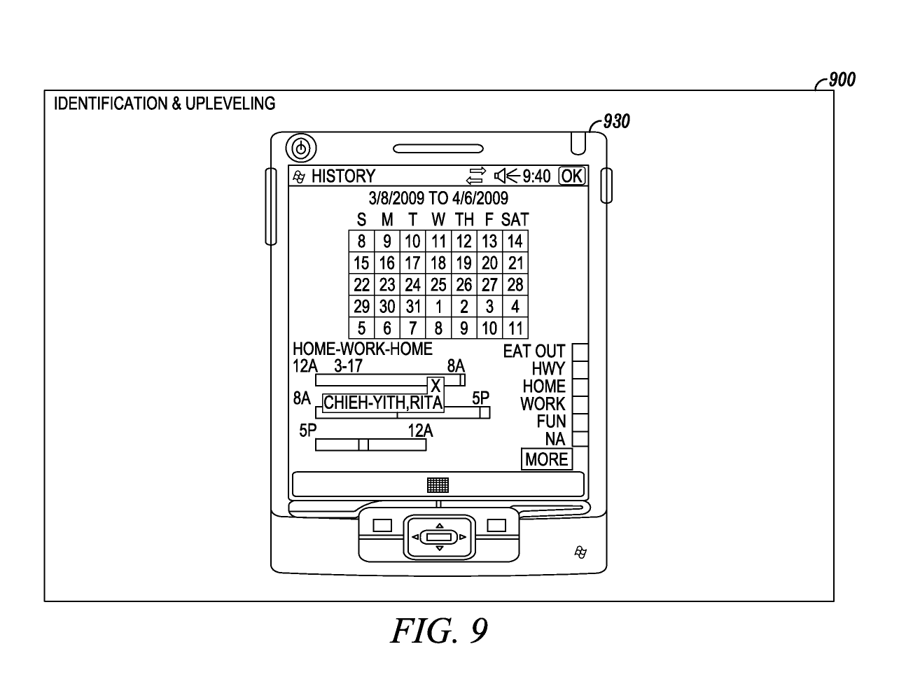

FIG. 9 at 900 illustrates identification and upleveling and shows how a user's day could then be summarized and presented to the user using a simple intuitive display. Public directories of GPS coordinates typically do not identify residential areas as well as other common places. Further the present invention may build heuristics and use multiple inputs to identify locations and use day of week as well as previous behavior to identify a day using the day templates as guidelines. The screen presented to the user 930 shows a calendar view. The individual numbers on the calendar representing the dates can be color-coded to represent the different day template, for example, dark blue can be an intense work day while light blue can represent a fun work day. In addition, clicking on a date on the calendar will show the day's detail. In the example 930, it is a Home-Work-Home day. Underneath that, the embodiment shows the day to the user divided into 3 lines (line 1: 12 am-8 am, line 2: 8 am-5 pm, line 3: 5 pm-12 am). Each line can be further divided into the major activities that the user was involved in during those time periods as well as color code them based on their types. For example, the user was at home from 12 am till 7:25 am, so that part of the first line can be color coded red, then the user commuted from 7:25 am till 8:05 am, the respective time can be shown as such and colored in yellow. The screen of 930 shows a legend for the color coding to the right side of the 3 lines. At the bottom of the screen in 930, there is a More button which when clicked can pop a flowchart on the screen with detailed information of the locations such as specific addresses and/or GPS coordinates. The user can also obtain information about people nearby by pointing to any part of the 3 time lines. She will be presented with a small pop-up window showing the names of friends and family members that were present nearby at that particular time as detected by the system.

Heuristics may be used to identify the semantic meaning of specific locations:
Multiple inputs can be used to identify locations e.g. user stays overnight at a specific location=>home, or user has labeled a location as work on her calendar
Use day of week as well as previous behavior to identify day templates, e.g. user goes to a customer's site every Wednesday so categorize the day as work day even if the user did not go to regular work location.

These simple characterization of a user's day was used, in one embodiment to drive TV recommendations. In this case, recommendations were driven by past statistics, for example, based on what the user typically watches on TV at the end of an intense work day, as a winding down mechanism, or how long the user would want to watch TV before an upcoming travel work day with long hours. In another embodiment, a restaurant recommendation might be driven based on whether the person is stepping out from work or going out with friends on the weekend in order to determine whether the user is feeling up for being in a busy place with loud music or more of a calm restaurant where the service is fast.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method of using probabilistic techniques in trending and profiling of user behavior in order to offer recommendations, comprising:
detecting patterns in user behavior over time thereby enabling a personal device associated with said user to predict what said user is likely to do on a given day or what said user intends to accomplish in an action that has begun.

2. The method of claim 1, wherein based on said patterns detected, said personal device can tailor its interfaces or proactively act on a user's behalf.

3. The method of claim 1, further comprising creating a definition of each activity performed by said users and determining features and commonalities among these activities that are then extracted.

4. The method of claim 3, wherein transitions from one activity to another are assigned a probability based on the data collected and wherein said probability constitutes a score that can be used to influence recommendations that reflect a prediction of what said user is likely to do next.

5. The method of claim 4, wherein discovering patterns include a goal which includes specific things that happen at specific times over and over again and inputs include location, timing and people nearby.

6. An apparatus, comprising:
a personal device associated with a user adapted to use probabilistic techniques in trending and profiling of user behavior in order to offer recommendations by detecting patterns in user behavior over time thereby enabling a personal device associated with said user to predict what said user is likely to do on a given day or what said user intends to accomplish in an action that has begun.

7. The apparatus of claim 6, wherein based on said patterns detected said personal device can tailor its interfaces or proactively act on said user's behalf.

8. The apparatus of claim 6, further comprising said persona device adapted to create a definition of each activity performed by said users and determining features and commonalities among these activities that are then extracted.

9. The apparatus of claim 8, wherein transitions from one activity to another are then assigned a probability based on the data collected and wherein said probability constitutes a score that can be used to influence recommendations that reflect a prediction of what said user is likely to do next.

10. The apparatus of claim 9, wherein discovering patterns include a goal which includes specific things that happen at specific times over and over again and inputs include location, timing and people nearby.

11. A non-volatile computer readable medium encoded with computer executable instructions, which when accessed, cause a machine to perform operations comprising:
using probabilistic techniques in trending and profiling of user behavior in order to offer recommendations by detecting patterns in said user behavior over time thereby enabling said personal device associated with said user to predict what said user is likely to do on a given day or what said user intends to accomplish in an action that has begun.

12. The non-volatile computer readable medium encoded with computer executable instructions apparatus of claim 11, wherein based on said patterns detected said personal device can tailor its interfaces or proactively act on said user's behalf.

13. The non-volatile computer readable medium of claim 12, further comprising additional instructions causing said machine to perform further operations including creating a definition of each activity performed by said users and determining features and commonalities among these activities that are then extracted.

14. The non-volatile computer readable medium of claim 13, wherein transitions from one activity to another are then assigned a probability based on the data collected and wherein said probability constitutes a score that can be used to influence recommendations that reflect a prediction of what said user is likely to do next.

15. The computer readable medium of claim 14, wherein discovering patterns include a goal which includes specific things that happen at specific times over and over again and inputs include location, timing and people nearby.

16. A mobile device, comprising:
a processor adapted to use probabilistic techniques in trending and profiling of a user of said mobile device's behavior in order to offer recommendations by detecting patterns in said user behavior over time thereby enabling said mobile device to predict what said user is likely to do on a given day or what said user intends to accomplish in an action that has begun.

17. The mobile device of claim 16, wherein based on said patterns detected said mobile device, said mobile device can tailor its interfaces or proactively act on said user's behalf.

18. The mobile device of claim 16, wherein said mobile device is adapted to create a definition of each activity performed by said user and determine features and commonalities among these activities that are then extracted.

19. The mobile device of claim 18, wherein transitions from one activity to another are then assigned a probability based on the data collected and wherein said probability constitutes a score that can be used to influence recommendations that reflect a prediction of what said user is likely to do next.

20. The mobile device of claim 19, wherein discovering patterns include a goal which includes specific things that happen at specific times over and over again and inputs include location, timing and people nearby.
